(19) United States
(12) Patent Application Publication
(10) Pub. No.: US 2024/0392073 A1
(43) Pub. Date: Nov. 28, 2024

(54) CROSSLINKABLE MASSES BASED ON ORGANYLOXY-GROUP-CONTAINING ORGANOPOLYSILOXANES

(71) Applicant: Wacker Chemie AG, Munich (DE)

(72) Inventor: Wolfgang Ackermann, Burhausen (DE)

(73) Assignee: Wacker Chemie AG, Munich (DE)

(21) Appl. No.: 18/692,350

(22) PCT Filed: Oct. 26, 2021
(86) PCT No.: PCT/EP2021/079721

§ 371 Date: Mar. 15, 2024

(51) Int. Cl. C08G 77/20; C08G 77/08; C08G 77/18; C08K 5/5419; C08K 5/5425; C08K 5/544; C08L 83/08

(52) U.S. Cl. CPC C08G 77/20; C08G 77/08; C08G 77/18; C08K 5/5419; C08K 5/5425; C08K 5/544; C08L 83/08; C08G 2190/00; C08L 2205/025; C08L 2205/03; C08L 2312/00

(57) ABSTRACT

The Applicant respectfully request that the abstract of the instant application be removed in its entirety and replaced with the following wording.

A crosslinkable composition along with methods of producing and uses for the same. Where the crosslinkable composition includes a component (A) of substantially linear, organyloxy-terminated organopolysiloxanes of the formula (IV)

(OR²)_{3-f-h}R¹_{f}/RₕSi—(SiR₂—O)_{g}—SiR¹_{f}Rₕ(OR²)_{3-f-h} (IV),
a component (B) of organosilicon compounds of the formula (II)

(R⁴O)_{d}SiR³_{(4-d)} (II), and
a component (C) of organosilicon compounds containing basic nitrogen and of the formula (III)

(R⁶O)ₑSiR⁵₍₄₋ₑ₎ (III).
Where the weight ratio of component (B) to component (C) is in the range from 1:1 to 1:5.

The invention relates to crosslinkable compositions based on organopolysiloxanes containing organyloxy groups, featuring improved crosslinking behavior and achieving an inherent long-term fungicidal surface effect, to methods for producing them, and to their use.

One-component (RTV-1) sealants which are storable with exclusion of water but undergo vulcanization to elastomers at room temperature when water is admitted have been known for a long time. These products are employed in large quantities, for example, in the construction industry, as sealants for connecting joints or façade joints, or can be applied as elastic coatings. These mixtures are based on polymers terminated with silyl groups which carry reactive substituents such as OH groups or hydrolyzable groups, such as alkoxy groups, for example. Furthermore, these sealant compounds may comprise fillers, plasticizers, crosslinkers, catalysts, and additives. Reference may be made in this regard, for example, to EP-A 327847, EP-A 1865029, EP-A 1479720 and EP-A 1042400 and EP-A 3565857. Alkoxy-RTV-1 compositions are preferred on account of their neutral and odorless crosslinking and the very good adhesion to different substrates, relative to other neutral systems. In the course of crosslinking and curing through volume, there is partial migration of crosslinkers and cleavage products to the interfaces of the joint, where they may often give rise, together with liquids that are used for smoothing, to visible non-removable structures. These systems are also incapable of preventing mold infestation and growth.

The object, then, was to provide crosslinkable compositions, based on organopolysiloxanes containing organyloxy groups, which avoid the disadvantages of the prior art.

A subject of the invention are crosslinkable compositions comprising
(A) organopolysiloxanes containing organyloxy groups and composed of units of the formula

RₐR¹_{b}(OR²)_{c}SiO_{(4-a-b-c)2} (I),
where
R may be identical or different and represents monovalent, SiC-bonded, optionally substituted hydrocarbon radicals that are free from aliphatic carbon-carbon multiple bonds,
R¹ may be identical or different and denotes monovalent, SiC-bonded, optionally substituted hydrocarbon radicals having aliphatic carbon-carbon multiple bonds,
R² may be identical or different and denotes monovalent, optionally substituted hydrocarbon radicals or hydrogen atom,
a is 0, 1 or 2,
b is 0 or 1, and
c is 0, 1 or 2,
with the proviso that in formula (I) the sum a+b+c≤3 and c is other than 0 in at least one unit,
(B) organosilicon compounds of the formula

(R₄O)_{d}SiR³_{(4-d)} (II),
where
R³ may be identical or different and denotes monovalent, SiC-bonded, optionally substituted hydrocarbon radicals,
R⁴ may be identical or different and denotes hydrogen atom or monovalent, optionally substituted hydrocarbon radicals,
d is 2, 3 or 4, preferably 3,
and/or their partial hydrolysates,
and
(C) organosilicon compounds containing basic nitrogen and of the formula

(R⁶O)_{c}SiR⁵₍₄₋ₑ₎ (III),
where

R⁵ may be identical or different and denotes monovalent, SiC-bonded radicals containing basic nitrogen,

R⁶ may be identical or different and denotes hydrogen atom or monovalent, optionally substituted hydrocarbon radicals, and
e is 2 or 3, preferably 3,
and/or their partial hydrolysates,
with the proviso that the weight ratio of component (B) to component (C) is in the range from 1:1 to 1:5.

In the context of the present invention, the term “organopolysiloxanes” is intended to encompass polymeric, oligomeric, and dimeric siloxanes.

The crosslinkable compositions are preferably compositions which can be crosslinked by condensation reaction.

In the context of the present invention, the designation “condensation reaction” is intended also to encompass any preceding hydrolysis step.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl radical and methylcyclohexyl radicals; aryl radicals, such as the phenyl, naphthyl, anthryl, and phenanthryl radical; alkaryl radicals, such as o-, m-, and p-tolyl radicals; xylyl radicals and ethylphenyl radicals; and aralkyl radicals, such as the benzyl radical, the α- and the β-phenylethyl radical.

Examples of substituted radicals R are methoxyethyl, ethoxyethyl, ethoxyethoxyethyl radical or polyoxyalkyl radicals such as polyethylene glycol or polypropylene glycol radicals.

Radical R preferably comprises monovalent hydrocarbon radicals having 1 to 18 carbon atoms that are free from aliphatic carbon-carbon multiple bonds and that are optionally substituted by halogen atoms, amino groups, ether groups, ester groups, epoxy groups, mercapto groups, cyano groups or (poly)glycol radicals, and more preferably comprises monovalent hydrocarbon radicals having 1 to 12 carbon atoms that are free from aliphatic carbon-carbon multiple bonds, and more particularly comprises the methyl radical.

Examples of radicals R¹ are alkenyl radicals, such as linear or branched 1-alkenyl radicals such as the vinyl radical and 1-propenyl radical and also the 2-propenyl radical.

Radical R¹ preferably comprises monovalent hydrocarbon radicals having 1 to 18 carbon atoms that have aliphatic carbon-carbon multiple bonds and that are optionally substituted by halogen atoms, amino groups, ether groups, ester groups, epoxy groups, mercapto groups, cyano groups or (poly)glycol radicals, and more preferably comprises monovalent hydrocarbon radicals having 1 to 12 carbon atoms and having aliphatic carbon-carbon multiple bonds, and more particularly comprises the vinyl radical.

Examples of radicals R² are the monovalent radicals stated for R and R¹.

Radical R² preferably comprises monovalent, optionally substituted hydrocarbon radicals having 1 to 12 carbon atoms that may be interrupted by oxygen atoms, and more preferably comprises alkyl radicals having 1 to 6 carbon atoms, and more particularly the methyl or ethyl radical, and very preferably comprises the methyl radical.

Examples of component (A) are

(MeO)₂MeSiO[SiMe₂O]₂₀₀₋₂₀₀₀SiMe₃,

Me₃SiO[SiMe₂O]₂₀₀₋₂₀₀₀SiVi(OMe)₂,

(MeO)₂MeSiO[SiMe₂O]₂₀₀₋₂₀₀₀SiVi(OMe)₂

(MeO)₂ViSiO[SiMe₂O]₂₀₁₀₋₂₀₁₀)SiVi(OMe)₂,

(MeO)₂MeSiO[SiMe₂O]₂₀₀₋₂₀₀₀SiViMe(OMe),

(MeO)ViMeSiO[SiMe₂O]₂₀₀₋₂₀₀₀SiViMe(OMe) and

(MeO)ViMeSiO[SiMe₂O]₂₀₀₋₂₀₀₀)SiVi(OMe)₂,
where Me denotes methyl radical and Vi denotes vinyl radical.

Organopolysiloxanes (A) used in accordance with the invention are preferably substantially linear, organyloxy-terminated organopolysiloxanes, more preferably those of the formula

(OR²)_{3-f-h}R¹_{f}RₕSi—(SiR₂—O)_{g}—SiR¹_{f}Rₕ(OR²)_{3-f-h} (IV),
where
R, R¹ and R² may each be identical or different and have one of the definitions stated above, g is 30 to 5000,
f is 0, 1 or 2, preferably 1, and
h is 0, 1, 2 or 3, preferably 0 or 3,
with the proviso that the sum f+h≤3 and the compounds of the formula (IV) have at least one radical R¹ and at least one radical OR².

Although not specified in formula (IV), the organopolysiloxanes (A) used in accordance with the invention may, resulting from their preparation, have a small proportion of branches, preferably up to a maximum of 500 ppm of all the Si units, more particularly none.

Preferred examples of organopolysiloxanes (A) are

(MeO)₂MeSiO[SiMe₂O]₂₀₀₋₂₀₀₀SiVi(OMe)₂

(MeO)₂VisiO[SiMe₂O]₂₀₀₋₂₀₀₀SiVi(OMe)₂,

(MeO)₂MeSiO[SiMe₂O]₂₀₀₋₂₀₀₀SiViMe(OMe),

(MeO)ViMeSiO[SiMe₂O]₂₀₀₋₂₀₀₀SiViMe(OMe) or

(MeO)ViMeSiO[SiMe₂O]₂₀₀₋₂₀₀₀SiVi(OMe)₂, where

(MeO)₂MeSiO[SiMe₂O]₂₀₀₋₂₀₀₀SiVi(OMe)₂ or

(MeO)₂ViSiO[SiMe₂O]₂₀₀₋₂₀₀₀SiVi(OMe)₂, are particularly preferred,
more particularly (MeO)₂ViSiO [SiMe₂O]₂₀₀₋₂₀₀₀SiVi(OMe)₂, where Me denotes methyl radical and Vi denotes vinyl radical.

The organopolysiloxanes (A) used in accordance with the invention have a viscosity of preferably 10⁴ to 10⁶ mPa·s, more preferably 5000 to 500 000 mPa·s, in each case at 25° C.

The organopolysiloxanes (A) are commercially customary products and/or can be prepared and isolated by methods commonplace within silicon chemistry, prior to blending.

Examples of radicals R³ are the monovalent radicals stated for R and R¹.

Radical R³ preferably comprises monovalent hydrocarbon radicals having 1 to 12 carbon atoms that are optionally substituted by ether groups, ester groups, (poly)glycol radicals or triorganyloxysilyl groups, and more preferably comprises alkyl radicals having 1 to 12 carbon atoms or alkenyl radicals having 1 to 12 carbon atoms, and more particularly comprises the methyl radical or the vinyl radical, and especially preferably comprises the vinyl radical.

Examples of radicals R⁴ are hydrogen atom and the monovalent radicals stated for R and R¹.

Radical R⁴ preferably comprises monovalent, optionally substituted hydrocarbon radicals having 1 to 12 carbon atoms, that may be interrupted by oxygen atoms, and more preferably comprises alkyl radicals having 1 to 6 carbon atoms, more particularly the methyl or ethyl radical.

The organosilicon compounds (B) used in the compositions of the invention are preferably silanes having at least one ethoxy radical or their partial hydrolysates, more preferably tetraethoxysilane, methyltriethoxysilane, dimethyldiethoxysilane, vinyltriethoxysilane, vinylmethyldiethoxysilane, phenyltriethoxysilane, phenylmethyldiethoxysilane or 1,2-bis(triethoxysilyl) ethane or their partial hydrolysates, more particularly tetraethoxysilane, methyltriethoxysilane or vinyltriethoxysilane and/or their partial hydrolysates, especially preferably vinyltriethoxysilane or its partial hydrolysates.

The partial hydrolysates (B) may be partial homohydrolysates, i.e., partial hydrolysates of one kind of organosilicon compound of the formula (II), and also partial cohydrolysates, i.e., partial hydrolysates of at least two different kinds of organosilicon compounds of the formula (II).

Where the compounds (B) used in the compositions of the invention are partial hydrolysates of organosilicon compounds of the formula (II), those having up to 10 silicon atoms are preferred.

The crosslinkers (B) used in the compositions of the invention are commercially customary products and/or can be prepared by methods that are known within silicon chemistry.

The compositions of the invention comprise component (B) in amounts of preferably 0.5 to 15.0 parts by weight, more preferably 0.5 to 10.0 parts by weight, more particularly 0.6 to 7.0 parts by weight, based in each case on 100 parts by weight of organopolysiloxanes (A).

In one preferred embodiment of the invention, component (B) comprises compounds of the formula (II) in which at least one radical R⁴ is ethyl radical.

Component (B) preferably comprises, at least in part, compounds of the formula (II) in which at least one radical R³ is alkenyl radical having 1 to 12 carbon atoms.

Component (B) used in the invention more preferably consists to an extent of 30 to 100 percent by weight, more particularly 60 to 100 percent by weight, of compounds of the formula (II) in which at least one radical R³ is vinyl radical.

Examples of radicals R⁵ are radicals of the formulae H₂NCH₂—, H₂N(CH₂)₂—, H₂N(CH₂)₃—, H₂N(CH₂)₂NH(CH₂)₂—, H₂N(CH₂)₂NH(CH₂)₃—, H₂N(CH₂)₂NH(CH₂)₂NH(CH₂)₃—, H₃CNH(CH₂)₃—, C₂H₅NH(CH₂)₃—, H₃CNH(CH₂)₂—, C₂H₅NH(CH₂)₂—, H₂N(CH₂)₄—, H₂N(CH₂)₅—, H(NHCH₂CH₂)₃—, C₄H₉NH(CH₂)₂NH(CH₂)₂—, cyclo-C₆H₁₁NH(CH₂)₃—, cyclo-C₆H₁₁NH(CH₂)₂—, (CH₃)₂N(CH₂)₃—, (CH₃)₂N(CH₂)₂—, (C₂H₅)₂N(CH₂)₃— and (C₂H₅)₂N(CH₂)₂—.

Radical R⁵ preferably comprises H₂N(CH₂)₃—, H₂N(CH₂)₂NH(CH₂)₃—, H₃CNH(CH₂)₃—, C₂H₅NH(CH₂)₃— or cyclo-C₆H₁₁NH(CH₂)₃-radical, more particularly the H₂N(CH₂) 2NH(CH₂) 3-radical.

Examples of radical R⁶ are hydrogen atom and also the examples stated for radical R².

Radical R⁶ preferably comprises monovalent, optionally substituted hydrocarbon radicals having 1 to 12 carbon atoms, that may be interrupted by oxygen atoms, and more preferably comprises alkyl radicals having 1 to 6 carbon atoms, and more particularly comprises the methyl or ethyl radical.

The organosilicon compounds (C) are preferably 3-aminopropyltrimethoxysilane, 3-aminopropyltriethoxysilane, 3-aminopropylmethyldimethoxysilane, 3-aminopropylmethyldiethoxysilane, N-(2-aminoethyl)-3-aminopropyltrimethoxysilane, N-(2-aminoethyl)-3-aminopropyltriethoxysilane, N-(2-aminoethyl)-3-aminopropylmethyldimethoxysilane, N-phenyl-3-aminopropyltrimethoxysilane, N-phenyl-3-aminopropylmethyldimethoxysilane, N-phenyl-3-aminopropyltriethoxysilane or N-phenyl-3-aminopropylmethyldiethoxysilane, or further N-alkyl or N,N-dialkyl derivatives of 3-aminopropyltrimethoxysilane, 3-aminopropyltriethoxysilane, 3-aminopropylmethyldimethoxysilane or 3-aminopropylmethyldiethoxysilane or their partial hydrolysates, where the stated N-alkyl radicals are preferably methyl, ethyl, n-propyl, isopropyl, n-butyl, isobutyl, tert-butyl, cyclohexyl or the various branched or unbranched pentyl or hexyl radicals.

The compounds (C) are more preferably 3-aminopropyltrimethoxysilane, 3-aminopropyltriethoxysilane, N-(2-aminoethyl)-3-aminopropyltrimethoxysilane or N-(2-aminoethyl)-3-aminopropyltriethoxysilane, more particularly N-(2-aminoethyl)-3-aminopropyltrimethoxysilane or N-(2-aminoethyl)-3-aminopropyltriethoxysilane.

The compounds (C) used in the compositions of the invention are commercially customary products and/or can be prepared by methods that are known within silicon chemistry.

The compositions of the invention comprise component (C) in amounts of preferably 0.5 to 20.0 parts by weight, more preferably 1.0 to 16.0 parts by weight, more particularly 1.4 to 14.0 parts by weight, based in each case on 100 parts by weight of organopolysiloxanes.

The weight ratio of component (B) to component (C) is preferably in the range from 1:1.5 to 1:3, more preferably in the range from 1:1.6 to 1:2.6.

Additionally to the components (A), (B) and (C), the compositions of the invention may now comprise all further substances which have also been employed to date in compositions which can be crosslinked by condensation reaction; examples of such further substances include (D) plasticizers, (E) fillers, (F) catalysts, (G) stabilizers, and (H) additives.

Examples of optionally employed plasticizers (D) are dimethylpolysiloxanes which are liquid at room temperature under a pressure of 1003 hPa and are terminated with trimethylsiloxy groups, in particular having viscosities at 25° C. in the range between 5 and 5000 mPa·s; organopolysiloxanes which are liquid at room temperature under a pressure of 1013 hPa and consist substantially of —SiO_{3/2}, —SiO_{2/2} and ≡SiO_{1/2} units, referred to as T, D and M units; and also high-boiling hydrocarbons, such as, for example, paraffin oils or mineral oils consisting substantially of naphthenic and paraffinic units.

The optionally employed plasticizer (D) preferably comprises linear polydimethylsiloxanes having trimethylsilyl end groups.

If the compositions of the invention do include plasticizers (D), the amounts involved are preferably 10 to 300 parts by weight, more preferably 10 to 200 parts by weight, more particularly 20 to 100 parts by weight, based in each case on 100 parts by weight of organopolysiloxane (A). Preferably, the compositions of the invention do include component (D).

Examples of fillers (E) are nonreinforcing fillers, these being fillers having a BET surface area of up to 50 m²/g, such as uncoated calcium carbonates, coated calcium carbonates, quartz, diatomaceous earth, calcium silicate, zirconium silicate, zeolites, metal oxide powders, such as aluminum, titanium, iron or zinc oxides and/or their mixed oxides, barium sulfate, gypsum, silicon nitride, silicon carbide, boron nitride, or glass powders and polymeric powders, such as polyacrylonitrile powders. Examples of reinforcing fillers, these being fillers having a BET surface area of more than 50 m²/g, are pyrogenically produced silica, precipitated silica, carbon blacks, such as furnace black and acetylene black, and mixed silicon-aluminum oxides of high BET surface area. It is also possible, furthermore, to use fibrous fillers such as polymeric fibers. The stated fillers may have been hydrophobized, by treatment, for example, with organosilanes and/or organosiloxanes, stearic acid derivative, or by etherification of hydroxyl groups to alkoxy groups.

If fillers (E) are used, they are preferably untreated calcium carbonates, hydrophilic, pyrogenically produced silica, or hydrophobic, pyrogenically produced silica.

If the compositions of the invention do include fillers (E), the amounts involved are preferably 10 to 500 parts by weight, more preferably 10 to 200 parts by weight, very preferably 50 to 200 parts by weight, based in each case on 100 parts by weight of organopolysiloxane (A).

As catalyst (F) it is possible to use all curing accelerators which have also been employed to date in compositions which can be crosslinked by condensation reaction. Examples of optionally employed catalysts (F) are organotin compounds, such as di-n-butyltin dilaurate and di-n-butyltin diacetate, di-n-butyltin oxide, dioctyltin diacetate, dioctyltin dilaurate, dioctyltin oxide, and also reaction products of these compounds with alkoxysilanes and organo-functional alkoxysilanes, such as tetraethoxysilane and aminopropyltriethoxysilane; preferred are di-n-butyltin dilaurate, dioctyltin dilaurate, reaction products of dibutyltin oxide and dioctyltin oxide with tetraethyl silicate hydrolysate or mixed hydrolysates with aminopropylsilanes.

If the compositions of the invention do include catalysts (F), which is preferred, the amounts involved are preferably 0.01 to 3 parts by weight, more preferably 0.05 to 2 parts by weight, based in each case on 100 parts by weight of organopolysiloxane (A).

Preferred examples of stabilizers (G) are phosphoric acid, phosphonic acids, phosphonic acid alkyl esters, and phosphoric acid alkyl esters.

If the compositions of the invention do include stabilizers (G), which is preferred, the amounts involved are preferably 0.01 to 100 parts by weight, more preferably 0.05 to 30 parts by weight, more particularly 0.05 to 10 parts by weight, based in each case on 100 parts by weight of organopolysiloxane (A).

Examples of additives (H) are pigments, dyes, odorants, oxidation inhibitors, agents for influencing the electrical properties, such as conductive carbon black, flame retardants, light stabilizers, fungicides, heat stabilizers, scavengers, such as Si—N-containing silazanes or silylamides, cocatalysts, thixotropic agents, such as, for example, polyethylene glycols, polypropylene glycols or copolymers thereof, organic solvents, such as alkyl aromatics, paraffin oils, and also any desired siloxanes different from component (A).

If the compositions of the invention do include additives (H), the amounts involved are preferably 0.01 to 100 parts by weight, more preferably 0.05 to 30 parts by weight, more particularly 0.05 to 10 parts by weight, based in each case on 100 parts by weight of organopolysiloxane (A).

The compositions of the invention are preferably compositions comprising
(A) organopolysiloxanes composed of units of the formula (I),
(B) organosilicon compounds of the formula (II) and/or their partial hydrolysates,
(C) organosilicon compounds containing basic nitrogen and of the formula (III) and/or their partial hydrolysates,
optionally (D) plasticizers,
optionally (E) fillers,
optionally (F) catalysts,
optionally (G) stabilizers and
optionally (H) additives,
with the proviso that the weight ratio of component (B) to component (C) is in the range from 1:1 to 1:5.

The compositions of the invention are more preferably compositions comprising
(A) organopolysiloxanes of the formula (IV) in which R is methyl radical and R¹ is vinyl radical,
(B) organosilicon compounds comprising at least one compound of the formula (II) in which R⁴ is ethyl radical and/or their partial hydrolysates,
(C) organosilicon compounds containing basic nitrogen and of the formula (III) selected from N-(2-aminoethyl)-3-aminopropyltrimethoxysilane and N-(2-aminoethyl)-3-aminopropyltriethoxysilane, and their partial hydrolysates,
(D) plasticizers,
optionally (E) fillers,
optionally (F) catalysts,
(G) stabilizers, and
optionally (H) additives,
with the proviso that the weight ratio of component (B) to component (C) is in the range from 1:1 to 1:5.

The compositions of the invention are more particularly compositions comprising (A) organopolysiloxanes selected from the compounds

(MeO)₂MeSiO[SiMe₂O]₂₀₀₋₂₀₀₀SiVi(OMe)₂

(MeO)₂ViSiO[SiMe₂O]₂₀₀₋₂₀₀₀SiVi(OMe)₂,

(MeO)₂MeSiO[SiMe₂O]₂₀₀₋₂₀₀₀SiViMe(OMe),

(MeO)ViMeSiO[SiMe₂O]₂₀₀₋₂₀₀₀SiViMe(OMe) and

(MeO)ViMeSiO[SiMe₂O]₂₀₀₋₂₀₀₀SiVi(OMe)₂,
(B) organosilicon compounds selected from methyltrimethoxysilane, dimethyldimethoxysilane, vinyltrimethoxysilane, vinylmethyldimethoxysilane, 1,2-bis(trimethoxysilyl) ethane, methyltrimethoxysilane, dimethyldiethoxysilane, vinyltriethoxysilane, vinylmethyldiethoxysilane, 1,2-bis(triethoxysilyl) ethane and their partial hydrolysates,
(C) organosilicon compounds containing basic nitrogen and selected from N-(2-aminoethyl)-3-aminopropyltrimethoxysilane and N-(2-aminoethyl)-3-aminopropyltriethoxysilane, and their partial hydrolysates,
(D) plasticizers,
optionally (E) fillers,
(F) catalysts,
(G) stabilizers, and
optionally (H) additives,
with the proviso that the weight ratio of component (B) to component (C) is in the range from 1:1.5 to 1:3.

In a further, more particularly preferred embodiment, the compositions of the invention are compositions comprising
(A) organopolysiloxanes selected from the compounds

Me₃SiO[SiMe₂O]₂₀₀₋₂₀₀₀SiVi(OMe)₂,

(MeO)₂MeSiO[SiMe₂O]₂₀₀₋₂₀₀₀SiVi(OMe)₂,

(MeO)₂VisiO[SiMe₂O]₂₀₀₋₂₀₀₀SiVi(OMe)₂ and

(MeO)₂MeSiO[SiMe₂O]₂₀₀₋₂₀₀₀SiMe(OMe)₂
(B) organosilicon compounds selected from the compounds methyltrimethoxysilane, vinyltrimethoxysilane, methyltriethoxysilane and vinyltriethoxysilane and their partial hydrolysates,
(C) organosilicon compounds containing basic nitrogen and selected from N-(2-aminoethyl)-3-aminopropyltrimethoxysilane and N-(2-aminoethyl)-3-aminopropyltriethoxysilane, and their partial hydrolysates,
(D) plasticizers,
optionally (E) fillers,
(F) catalysts,
(G) stabilizers, and
optionally (H) additives,
with the proviso that the weight ratio of component (B) to component (C) is in the range from 1:1.5 to 1:3.

In another more particularly preferred embodiment, the compositions of the invention are compositions comprising
(A) (MeO)₂ViSiO [SiMe2O]₂₀₀₋₂₀₀₀SiVi(OMe)₂,
(B) organosilicon compounds selected from the compounds methyltrimethoxysilane, vinyltrimethoxysilane, methyltriethoxysilane and vinyltriethoxysilane, and their partial hydrolysates,
(C) organosilicon compounds containing basic nitrogen and selected from N-(2-aminoethyl)-3-aminopropyltrimethoxysilane and N-(2-aminoethyl)-3-aminopropyltriethoxysilane, and their partial hydrolysates,
(D) plasticizers,
optionally (E) fillers,
(F) catalysts,
(G) stabilizers, and
optionally (H) additives,
with the proviso that the weight ratio of component (B) to component (C) is in the range from 1:1.5 to 1:3.

The compositions of the invention preferably contain no further constituents beyond the components (A) to (H).

The individual constituents of the compositions of the invention may in each case comprise one kind of such a constituent or else a mixture of at least two different kinds of such constituents.

The compositions of the invention comprise liquid or viscous mixtures, and preferably are viscid to pasty compositions.

The compositions of the invention may be prepared by mixing all of the constituents with one another in any order.

A further subject of the present invention is a method for producing the compositions of the invention by mixing the individual components in any order; preferably, first, from components (B) and (C), a premix (BC) is prepared, and is then mixed with components (A) and optionally (D) to (H).

This mixing may take place at room temperature under the pressure of the surrounding atmosphere, in other words about 900 to 1100 hPa. If desired, however, this mixing may also take place at higher temperatures, as for example at temperatures in the range from 35 to 100° C. It is possible, moreover, to carry out mixing occasionally or continuously under reduced pressure, such as at absolute pressure of 30 to 900 hPa, for example, in order to remove volatile compounds or air.

The mixing according to the invention takes place preferably in the absence of atmospheric moisture.

The premix (BC) is prepared preferably by mixing components (B) and (C) in the absence of atmospheric moisture and storing this mixture for at least 7 days at 5 to 30° C. and in the absence of atmospheric moisture.

Preferably, the components (A), (BC), (G) and optionally plasticizer (D) are mixed, preferably with trimethylsilyl-terminated organopolysiloxanes. This may occur under the pressure of the atmosphere or else under reduced pressure. Subsequently it is possible to mix in fillers (E) and to carry out dispersing in the mixer with relatively strong shearing at relatively high rotary speeds. This is generally done under reduced pressure in order to remove volatile compounds, air, and reaction products of the moisture of the fillers with components (B) and (C). Further constituents, such as stabilizers (G) or additives (H), may be added before or together with the fillers (E). If catalyst (F) is used, it is stirred in homogeneously at the end. This is generally done under reduced pressure, in order to make the pasty compositions bubble-free.

The customary water content of the air is sufficient to crosslink the compositions of the invention. Crosslinking of the compositions of the invention is accomplished preferably at room temperature. It may, if desired, also be carried out at temperatures higher or lower than room temperature, as for example at −5° to 15° C. or at 30° C. to 50° C., and/or by means of concentrations of water that exceed the normal water content of the air. The direct admixing of water or hydrous substances is also possible.

The crosslinking is carried out preferably at a pressure of 100 to 1100 hPa, more particularly under the pressure of the surrounding atmosphere, in other words about 900 to 1100 hPa.

A further subject of the present invention are moldings produced by crosslinking the compositions of the invention.

The compositions of the invention can be used for any purposes for which it is possible to use compositions that are storable with exclusion of water and crosslink to elastomers at room temperature when water is admitted.

The compositions of the invention are outstandingly suitable, for example, as sealing compounds for joints, including perpendicular joints, and similar gaps of, for example, 10 to 40 mm in clear width, in—for example—buildings and land, water and air vehicles, or as adhesives or cementing compounds, in window construction or in the manufacture of glass cabinets, for example, and also, for example, for producing elastic protective coatings, including those for surfaces exposed continually to sunlight, rainwater, freshwater or salt water, or anti-slip coverings or rubber-elastic moldings, and also for the insulation of electrical or electronic apparatus. Furthermore, the compositions of the invention are also suitable for producing coatings on surfaces that are applied by brush or roller or else can be applied by spraying.

The compositions of the invention have the advantage that they are easy to produce and are distinguished by very high storage stability.

Furthermore, the compositions of the invention have the advantage that they have very good handling qualities during application and exhibit excellent processing properties across a multitude of applications.

In particular, the compositions of the invention are notable for forming smooth, amine-containing surfaces of low filler content that exhibit few visually disruptive effects, or none, after smoothing with smoothing agents or water, such as white streaks, for instance, and which counteract the development of algae and molds.

The compositions of the invention have the advantage that they cure effectively even under different climatic conditions. The crosslinking, accordingly, is more independent of the ambient temperature and the atmospheric humidity. At the same time, the compositions of the invention with sufficient rapidity develop an internal strength (cohesion) which prevents the partially vulcanized compositions from rupturing or blistering as a result, for example, of shrinkage or of movements in the substrate, which would cause them to lose their sealing function.

Unless otherwise stated, the examples which follow are carried out at a pressure of the surrounding atmosphere, in other words approximately at 1000 hPa, and at room temperature, in other words at approximately 23° C., and/or at a temperature which comes about when the components are combined at room temperature without additional heating or cooling, and also at a relative atmospheric humidity of approximately 50%. Furthermore, all figures for parts and percentages, unless otherwise stated, are by weight.

The skin-forming times are determined on extruded sealant beads 1 cm thick, by using a freshly sharpened pencil of hardness HB to contact the surface at a shallow angle at regular intervals. In this case, if material no longer remains hanging from the tip of the pencil when the pencil is slowly raised, and a fine skin lifts off, the time is recorded. After one day, the quality of the vulcanization is additionally examined on the basis of the tackiness of the surface and the tear strength of the sealant beads (fingernail test).

Curing through volume is determined using the so-called wedge method. In this method the material is introduced uniformly into a Teflon block milled to a depth of 0-10 mm and is tested daily by lifting of the bead from the shallow end. The depth at which the bead still remains hanging with tack to the base is recorded.

For investigating the mechanical properties of the cured compositions, the paste is applied by knife or doctor blade, in thin layers, to a poorly adhering substrate, and is cured over 14 days at 23° C. and 50% relative atmospheric humidity. Used preferably for this purpose are Teflon molds which are cut out to a depth of 2 mm and filled completely with the composition, the surface being made uniformly smooth by doctor blade prior to curing.

The mechanical values are determined in accordance with ISO 37 on S2 specimens.

The Shore A hardness is determined in accordance with ISO 868.

The modes of action of microorganisms are evaluated in accordance with ISO 846, method B, with G corresponding to extent of growth, I to zone of inhibition, and D to discoloration.

### EXAMPLE 1

560 g of polymer mixture (A1), consisting of 476 g of polydimethylsiloxane with dimethoxyvinylsilyl end groups and dimethoxymethylsilyl end groups in a molar ratio of 2:1 and with a viscosity of 90 000 mPa·s and 84 g of trimethylsilyl-end-terminated polydimethylsiloxane with a viscosity of 100 mPa′s, 129.6 g of trimethylsilyl-end-terminated polydimethylsiloxane with a viscosity of 1000 mPa·s, 2.4 g of octylphosphonic acid mixture composed of 25-30% trimethoxymethylsilane and 70-75% octylphosphonic acid, and 32.0 g of a premix (BC1) consisting of 10.2 g of vinyltriethoxysilane, 3.2 g of N-aminoethylaminopropyl-trimethoxysilane and 18.6 g of N-aminoethylaminopropyl-triethoxysilane were homogenized in a laboratory planetary mixer for a duration of 3 minutes at 300 rpm and a pressure of 200-300 hPa. Subsequently, 72.0 g of a hydrophilic, pyrogenic silica having a specific surface area of 150 m²/g were mixed in slowly at a pressure of 900-1100 hPa and dispersed for 5 minutes at 800 rpm and a pressure of 200-300 hPa. Lastly, the resultant paste was activated with 4.0 g of a tin catalyst consisting of 17% dioctyltin oxide and 83% of a reaction product of aminopropyltriethoxysilane and ethoxy-terminated methyl-silsesquioxane for 3 minutes at 300 rpm and a pressure of 200-300 hPa and stirred to remove bubbles.

The composition thus prepared was dispensed for keeping into moisture-tight containers and prior to the further tests was stored for 24 hours at 23° C.

The compositions obtained were thereafter investigated as described above or allowed to crosslink for 14 days at 23° C. and 50% relative humidity, and the mechanical properties, Shore hardness and modes of action of microorganisms were determined. The results are found in table 1.

### EXAMPLE 2 (NON-INVENTIVE; COMPARATIVE EXAMPLE)

The procedure described in example 1 is repeated with the modification that instead of 32.0 g of the premix (BC1), 16.0 g of vinyl-triethoxysilane and 12.0 g of N-aminoethylaminopropyl-trimethoxysilane are used and, instead of 129.6 g, 133.6 g of trimethylsilyl-end-terminated polydimethylsiloxane with a viscosity of 1000 mPa·s are used.

The results are found in table 1.

### EXAMPLE 3

The procedure described in example 1 is repeated with the modification that instead of 560 g, only 556 g of polymer mixture (A1) are used, and also 4.0 g of a PO-EO block polymer additive, a polymerization product of propylene oxide and ethylene oxide (available commercially under the designation “GENAPOL PF 40” from Clariant Produkte (Deutschland) GmbH) are used.

The results are found in table 1.

TABLE 1

| Example | | |
|---|---|---|
| | 2 | |
| 1 | (compar.) | 3 |

Paste properties

| | | | |
|---|---|---|---|
| Skin-forming time [min] | 16 | 20 | 16 |
| Surface tack | pos. | pos. | pos. |
| Tear strength | pos. | pos. | pos. |
| Surface appearance | pos. | pos. | pos. |

Film mechanical properties to ISO 37-S2

| | | | |
|---|---|---|---|
| 100% modulus [MPa] | 0.30 | 0.30 | 0.30 |
| Tensile strength [MPa] | 1.40 | 1.70 | 1.50 |
| Elongation at break [%] | 559 | 727 | 525 |

Shore A hardness to ISO 868

| | | | |
|---|---|---|---|
| Shore A top | 21.4 | 20.9 | 22.2 |

Modes of action of microorganisms to ISO 846/B

| | | | |
|---|---|---|---|
| G/I/D | 0/0/2 | 2/0/1-2 | 1/0/2 |
| A: Aspergillus niger van Tieghem | | | |
| ATCC 32656 | | | |
| G/I/D | 0/0/2 | 2/0/2 | 0/0/2 |
| B: Penicillium funiculosum Thom | | | |
| ATCC 36839 | | | |
| G/I/D | 0/0/2 | 3/0/1-2 | 0/0/2 |
| C: Paecilomyces varioti Bainier | | | |
| ATCC 10121 | | | |
| G/I/D | 1/0/2 | 2/0/1 | 0/0/1-2 |
| D: Gliocladium virens Miller et al. | | | |
| ATCC 9645 | | | |
| G/I/D | 0/0/1 | 0/0/1 | 0/0/1 |
| E: Chaetomium globosum Kunze: | | | |
| Fries | | | |

### EXAMPLE 4

300 g of a polydimethylsiloxane with dimethoxyvinylsilyl end groups and with a viscosity of 100 000 mPa·s, 106 g of a trimethylsilyl-end-terminated polydimethylsiloxane with a viscosity of 1000 mPa·s, 25.0 g of a dearomatized aliphatic mineral oil (available commercially under the designation “Hydroseal G 400 H” from TOTAL DEUTSCHLAND GMBH), 1.5 g of an octylphosphonic acid stabilizer, composed of 25-30% trimethoxymethylsilane and 70-75% octylphosphonic acid, and 20.0 g of the premix (BC1) described in example 1 were homogenized in a laboratory planetary mixer for a duration of 3 minutes at 300 rpm and a pressure of 200-300 hPa. Subsequently, 45.0 g of a hydrophilic, pyrogenic silica having a specific surface area of 150 m²/g were mixed in slowly at a pressure of 900-1100 hPa and dispersed for 5 minutes at 800 rpm and a pressure of 200-300 hPa. Lastly, the resulting paste was activated with 2.5 g of a tin catalyst, an octyl-organotin mixture containing around 17% dioctyltin oxide, for 3 minutes at 300 rpm and a pressure of 200-300 hPa and stirred to remove bubbles.

The results are found in table 2.

### EXAMPLE 5

The procedure described in example 4 is repeated with the modification that instead of 106 g, only 101 g of the trimethylsilyl-end-terminated polydimethylsiloxane with a viscosity of 1000 mPa·s are used and also 5.0 g of a fungicide paste, containing 2-butyl-1,2-benzisothiazolin-3-one (available commercially under the designation “DENSIL™ DN” from Lonza Group Ltd.), are used.

The results are found in table 2.

TABLE 2

| | | |
|---|---|---|
| Example | 4 | 5 |

Paste properties

| | | |
|---|---|---|
| Skin-forming time [min] | 7 | 7 |
| Surface tack | pos. | pos. |
| Tear strength | pos. | pos. |
| Surface appearance | pos. | pos. |

Film mechanical properties to ISO 37-S2

| | | |
|---|---|---|
| 100% modulus [MPa] | 0.39 | 0.39 |
| Tensile strength [MPa] | 1.22 | 1.27 |
| Elongation at break [%] | 414 | 431 |

Shore A hardness to ISO 868

| | | |
|---|---|---|
| Shore A top | 21.0 | 20.0 |

Modes of action of microorganisms to ISO 846/B

| | | |
|---|---|---|
| G/I/D | 0/0/1 | 0/0/1 |
| A: Aspergillus niger van Tieghem ATCC 32656 | | |
| G/I/D | 0/0/2 | 0/5/1-2 |
| B: Penicillium funiculosum Thom ATCC 36839 | | |
| G/I/D | 0/0/1-2 | 0/0/1-2 |
| C: Paecilomyces varioti Bainier ATCC 10121 | | |
| G/I/D | 1/0/1 | 0/0/1 |
| D: Gliocladium virens Miller et al. ATCC 9645 | | |
| G/I/D | 0/0/2 | 0/5/1 |
| E: Chaetomium globosum Kunze: Fries | | |

### EXAMPLE 6

300 g of a polydimethylsiloxane with dimethoxyvinylsilyl end groups and with a viscosity of 100 000 mPa·s, 133.5 g of a trimethylsilyl-end-terminated polydimethylsiloxane with a viscosity of 1000 mPa·s, 1.5 g of an octylphosphonic acid stabilizer, composed of 25-30% trimethoxymethylsilane and 70-75% octylphosphonic acid, and 17.5 g of the premix (BC1) described in example 1 were homogenized in a laboratory planetary mixer for a duration of 3 minutes at 300 rpm and a pressure of 200-300 hPa. Subsequently, 45.0 g of a hydrophilic, pyogenic silica having a specific surface area of 150 m²/g were mixed in slowly at a pressure of 900-1100 hPa and dispersed for 5 minutes at 800 rpm and a pressure of 200-300 hPa. Lastly, the resulting paste was activated with 2.5 g of a tin catalyst, an octyl-organotin mixture containing around 17% dioctyltin oxide, for 3 minutes at 300 rpm and a pressure of 200-300 hPa and stirred to remove bubbles.

The results are found in table 3.

### EXAMPLE 7

The procedure described in example 6 is repeated with the modification that instead of 300.0 g, only 295.0 g of the polydimethylsiloxane with dimethoxyvinylsilyl end groups and with a viscosity of 100 000 mPa·s are used and also 5.0 g of a fungicide paste, containing 2-butyl-1,2-benzisothiazolin-3-one (available commercially under the designation “DENSIL™ DN” from Lonza Group Ltd.), are used.

The results are found in table 3.

TABLE 3

| | | |
|---|---|---|
| Example | 6 | 7 |

Paste properties

| | | |
|---|---|---|
| Skin-forming time [min] | 15 | 20 |
| Surface tack | pos. | pos. |
| Tear strength | pos. | pos. |
| Surface appearance | pos. | pos. |

Modes of action of microorganisms to ISO 846/B

| | | |
|---|---|---|
| G/I/D | 1/0/2 | 0/2/0-1 |
| A: Aspergillus niger van Tieghem ATCC 32656 | | |
| G/I/D | 1/0/2 | 0/3/2 |
| B: Penicillium funiculosum Thom ATCC 36839 | | |
| G/I/D | 1/0/2 | 0/>10/2 |
| C: Paecilomyces varioti Bainier ATCC 10121 | | |
| G/I/D | 2/0/2 | 0/0/2 |
| D: Gliocladium virens Miller et al. ATCC 9645 | | |
| G/I/D | 1/0/2 | 0/1/2 |
| E: Chaetomium globosum Kunze: Fries | | |

1-10. (canceled)

11. A crosslinkable composition, comprising:
(A) substantially linear, organyloxy-terminated organopolysiloxanes of the formula (IV)
(OR²)_{3-f-h}R¹_{f}RₕSi—(SiR₂—O)_{g}—SiR¹_{f}Rₕ(OR²)_{3-f-h} (IV),
wherein R may be identical or different and represents monovalent, SiC-bonded, optionally substituted hydrocarbon radicals that are free from aliphatic carbon-carbon multiple bonds,
wherein R¹ may be identical or different and denotes monovalent, SiC-bonded, optionally substituted hydrocarbon radicals having aliphatic carbon-carbon multiple bonds,
wherein R² may be identical or different and denotes monovalent, optionally substituted hydrocarbon radicals or hydrogen atom,
wherein g is 30 to 5000,
wherein f is 0, 1 or 2,
wherein h is 0, 1, 2 or 3, and
wherein the sum f+h≤3 and the compounds of the formula (IV) have at least one radical R¹ and at least one radical OR²;
(B) organosilicon compounds of the formula (II)
(R⁴O)_{d}SiR³_{(4-d)} (II),
wherein R³ may be identical or different and denotes monovalent, SiC-bonded, optionally substituted hydrocarbon radicals,
wherein R⁴ may be identical or different and denotes hydrogen atom or monovalent, optionally substituted hydrocarbon radicals,
wherein d is 2, 3 or 4, and/or
their partial hydrolysates;
(C) organosilicon compounds containing basic nitrogen and of the formula (III)
(R⁶O)ₑSiR⁵₍₄₋ₑ₎ (III),
wherein R⁵ may be identical or different and denotes monovalent, SiC-bonded radicals containing basic nitrogen,
wherein R⁶ may be identical or different and denotes hydrogen atom or monovalent, optionally substituted hydrocarbon radicals,
wherein e is 2 or 3, and/or
their partial hydrolysates; and
wherein the weight ratio of component (B) to component (C) is in the range from 1:1 to 1:5.

12. The crosslinkable composition of claim 11, wherein the substantially linear, organyloxy-terminated organopolysiloxanes (A) are
(MeO)₂MeSiO[SiMe₂O]₂₀₀₋₂₀₀₀SiVi(OMe)₂
(MeO)₂ViSiO[SiMe₂O]₂₀₀₋₂₀₀₀SiVi(OMe)₂,
(MeO)₂MeSiO[SiMe₂O]₂₀₀₋₂₀₀₀SiViMe(OMe),
(MeO)ViMeSiO[SiMe₂O]₂₀₀₋₂₀₀₀SiViMe(OMe) or
(MeO)ViMeSiO[SiMe₂O]₂₀₀₋₂₀₀₀SiVi(OMe)₂.

13. The crosslinkable composition of claim 11, wherein the organosilicon compounds (B) are tetramethoxysilane, methyltrimethoxysilane, dimethyldimethoxysilane, vinyltrimethoxysilane, vinylmethyldimethoxysilane, phenyltrimethoxysilane, phenylmethyldimethoxysilane, 1,2-bis(trimethoxysilyl) ethane, tetraethoxysilane, methyltriethoxysilane, dimethyldiethoxysilane, vinyltriethoxysilane, vinylmethyldiethoxysilane, phenyltriethoxysilane, phenylmethyldiethoxysilane or 1,2-bis(triethoxysilyl) ethane or their partial hydrolysates.

14. The crosslinkable composition of claim 11, wherein the organosilicon compounds (C) are 3-aminopropyltrimethoxysilane, 3-aminopropyltriethoxysilane, 3-aminopropylmethyldimethoxysilane, 3-aminopropylmethyldiethoxysilane, N-(2-aminoethyl)-3-aminopropyltrimethoxysilane, N-(2-aminoethyl)-3-aminopropyltriethoxysilane, N-(2-aminoethyl)-3-aminopropylmethyldimethoxysilane, N-phenyl-3-aminopropyltrimethoxysilane, N-phenyl-3-aminopropylmethyldimethoxysilane, N-phenyl-3-aminopropyltriethoxysilane or N-phenyl-3-aminopropylmethyldiethoxysilane, or further N-alkyl or N,N-dialkyl derivatives of 3-aminopropyltrimethoxysilane, 3-aminopropyltriethoxysilane, 3-aminopropylmethyldimethoxysilane or 3-aminopropylmethyldiethoxysilane or their partial hydrolysates, where the stated N-alkyl radicals are methyl, ethyl, n-propyl, isopropyl, n-butyl, isobutyl, tert-butyl, cyclohexyl or the various branched or unbranched pentyl or hexyl radicals.

15. The crosslinkable composition of claim 11, wherein the weight ratio of component (B) to component (C) is in the range from 1:1.5 to 1:3.

16. The crosslinkable composition of claim 11, wherein the weight ratio of component (B) to component (C) is in the range from 1:1.6 to 1:2.6.

17. The crosslinkable composition of claim 11, further comprises
(A) organopolysiloxanes composed of units of the formula (I),
RₐR¹_{b}(OR²)_{c}SiO_{(4-a-b-c)/2} (I),
wherein R may be identical or different and represents monovalent, SiC-bonded, optionally substituted hydrocarbon radicals that are free from aliphatic carbon-carbon multiple bonds,
wherein R¹ may be identical or different and denotes monovalent, SiC-bonded, optionally substituted hydrocarbon radicals having aliphatic carbon-carbon multiple bonds,
wherein R² may be identical or different and denotes monovalent, optionally substituted hydrocarbon radicals or hydrogen atom,
wherein a is 0, 1 or 2,
wherein b is 0 or 1,
wherein c is 0, 1 or 2, and
wherein in formula (I) the sum a+b+c≤3 and c is other than 0 in at least one unit;
(B) organosilicon compounds of the formula (II) and/or their partial hydrolysates;
(C) organosilicon compounds containing basic nitrogen and of the formula (III) and/or their partial hydrolysates,
optionally (D) plasticizers;
optionally (E) fillers;
optionally (F) catalysts;
optionally (G) stabilizers;
optionally (H) additives; and
wherein the weight ratio of component (B) to component (C) is in the range from 1:1 to 1:5.

18. The crosslinkable composition of claim 11, wherein the crosslinkable composition is a molding.

19. A method for producing the crosslinkable composition, comprising:
providing a component (A), wherein the component (A) is a substantially linear, organyloxy-terminated organopolysiloxanes of the formula (IV)
(OR²)_{3-f-h}R¹_{f}RₕSi—(SiR₂—O)_{g}—SiR¹_{f}Rₕ(OR²)_{3-f-h} (IV),
wherein R may be identical or different and represents monovalent, SiC-bonded, optionally substituted hydrocarbon radicals that are free from aliphatic carbon-carbon multiple bonds,
wherein R¹ may be identical or different and denotes monovalent, SiC-bonded, optionally substituted hydrocarbon radicals having aliphatic carbon-carbon multiple bonds,
wherein R² may be identical or different and denotes monovalent, optionally substituted hydrocarbon radicals or hydrogen atom,
wherein g is 30 to 5000,
wherein f is 0, 1 or 2,
wherein h is 0, 1, 2 or 3, and
wherein the sum f+h≤3 and the compounds of the formula (IV) have at least one radical R¹ and at least one radical OR²;
providing a component (B), wherein the component (B) is an organosilicon compound of the formula (II)
(R⁴O)_{d}SiR³_{(4-d)} (II),
wherein R³ may be identical or different and denotes monovalent, SiC-bonded, optionally substituted hydrocarbon radicals,
wherein R⁴ may be identical or different and denotes hydrogen atom or monovalent, optionally substituted hydrocarbon radicals,
wherein d is 2, 3 or 4, and/or
their partial hydrolysates;
providing a component (C), wherein the component (C) is an organosilicon compound containing basic nitrogen and of the formula (III)
(R⁶O)ₑSiR⁵₍₄₋ₑ₎ (III),
wherein R⁵ may be identical or different and denotes monovalent, SiC-bonded radicals containing basic nitrogen,
wherein R⁶ may be identical or different and denotes hydrogen atom or monovalent, optionally substituted hydrocarbon radicals,
wherein e is 2 or 3, and/or
their partial hydrolysates;
wherein component (A), component (B) and component (C) are mixed together in any order; and
wherein the weight ratio of component (B) to component (C) is in the range from 1:1 to 1:5.

20. The method of claim 19, further comprising the step of allowing the crosslinkable composition to crosslink.

21. The methods of claim 20, wherein the crosslinked composition is a molding.

22. The crosslinkable composition of claim 19, wherein the substantially linear, organyloxy-terminated organopolysiloxanes (A) are
(MeO)₂MeSiO[SiMe₂O]₂₀₀₋₂₀₀₀SiVi(OMe)₂
(MeO)₂ViSiO[SiMe₂O]₂₀₀₋₂₀₀₀SiVi(OMe)₂,
(MeO)₂MeSiO[SiMe₂O]₂₀₀₋₂₀₀₀SiViMe(OMe),
(MeO)ViMeSiO[SiMe₂O]₂₀₀₋₂₀₀₀SiViMe(OMe) or
(MeO)ViMeSiO[SiMe₂O]₂₀₀₋₂₀₀₀SiVi(OMe)₂.

23. The crosslinkable composition of claim 19, wherein the organosilicon compounds (B) are tetramethoxysilane, methyltrimethoxysilane, dimethyldimethoxysilane, vinyltrimethoxysilane, vinylmethyldimethoxysilane, phenyltrimethoxysilane, phenylmethyldimethoxysilane, 1,2-bis(trimethoxysilyl) ethane, tetraethoxysilane, methyltriethoxysilane, dimethyldiethoxysilane, vinyltriethoxysilane, vinylmethyldiethoxysilane, phenyltriethoxysilane, phenylmethyldiethoxysilane or 1,2-bis(triethoxysilyl) ethane or their partial hydrolysates.

24. The crosslinkable composition of claim 19, wherein the organosilicon compounds (C) are 3-aminopropyltrimethoxysilane, 3-aminopropyltriethoxysilane, 3-aminopropylmethyldimethoxysilane, 3-aminopropylmethyldiethoxysilane, N-(2-aminoethyl)-3-aminopropyltrimethoxysilane, N-(2-aminoethyl)-3-aminopropyltriethoxysilane, N-(2-aminoethyl)-3-aminopropylmethyldimethoxysilane, N-phenyl-3-aminopropyltrimethoxysilane, N-phenyl-3-aminopropylmethyldimethoxysilane, N-phenyl-3-aminopropyltriethoxysilane or N-phenyl-3-aminopropylmethyldiethoxysilane, or further N-alkyl or N,N-dialkyl derivatives of 3-aminopropyltrimethoxysilane, 3-aminopropyltriethoxysilane, 3-aminopropylmethyldimethoxysilane or 3-aminopropylmethyldiethoxysilane or their partial hydrolysates, where the stated N-alkyl radicals are methyl, ethyl, n-propyl, isopropyl, n-butyl, isobutyl, tert-butyl, cyclohexyl or the various branched or unbranched pentyl or hexyl radicals.

25. The crosslinkable composition of claim 19, wherein the weight ratio of component (B) to component (C) is in the range from 1:1.5 to 1:3.

26. The crosslinkable composition of claim 19, wherein the weight ratio of component (B) to component (C) is in the range from 1:1.6 to 1:2.6.

27. The crosslinkable composition of claim 19, further comprises
(A) organopolysiloxanes composed of units of the formula (I),
RₐR¹_{b}(OR²)_{c}SiO_{(4-a-b-c)/2} (I),
wherein R may be identical or different and represents monovalent, SiC-bonded, optionally substituted hydrocarbon radicals that are free from aliphatic carbon-carbon multiple bonds,
wherein R¹ may be identical or different and denotes monovalent, SiC-bonded, optionally substituted hydrocarbon radicals having aliphatic carbon-carbon multiple bonds,
wherein R² may be identical or different and denotes monovalent, optionally substituted hydrocarbon radicals or hydrogen atom,
wherein a is 0, 1 or 2,
wherein b is 0 or 1,
wherein c is 0, 1 or 2, and
wherein in formula (I) the sum a+b+c≤3 and c is other than 0 in at least one unit;
(B) organosilicon compounds of the formula (II) and/or their partial hydrolysates;
(C) organosilicon compounds containing basic nitrogen and of the formula (III) and/or their partial hydrolysates,
optionally (D) plasticizers;
optionally (E) fillers;
optionally (F) catalysts;
optionally (G) stabilizers;
optionally (H) additives; and
wherein the weight ratio of component (B) to component (C) is in the range from 1:1 to 1:5.
